(19) United States
(12) Patent Application Publication
(10) Pub. No.: US 2016/0239896 A1
(43) Pub. Date: Aug. 18, 2016

(54) Mobile Website Real Property Search and Map Display System and Method

(71) Applicant: Paul Shiu-Chang Chay, Wesley Chapel, FL (US)

(72) Inventor: Paul Shiu-Chang Chay, Wesley Chapel, FL (US)

(21) Appl. No.: 14/544,762

(22) Filed: Feb. 18, 2015

(51) Int. Cl. G06Q 30/06; G06Q 50/16; H04L 29/08

(52) U.S. Cl. CPC G06Q 30/0625; H04L 67/02; G06Q 50/167

(57) ABSTRACT

The mobile web applications allow a user to search on a web-map for real properties anywhere in the world using mobile web browser devices. By simply entering a property geographical location (i.e., city, county, state, or zip code), an area map is prompt on the device, and one or more color coded pins are simultaneously generated on the map to identify the locations and the types of properties for sale. When further clicking on a specific color coded pins, the user is further taken to a “Property Details” page, where further detailed property information is presented.

The invention provides a system and method of using an on-line worldwide web browser system to facilitate the near real-time search of real properties for sale on a web-map using mobile browser devices. The invention provides a unique way of quickly and repeatedly identifying the types of property and the necessary information of different real properties available in the market without DOM reload or map refresh.

### BACKGROUND

In the United States and many other countries, lands are mostly privately owned. Many real estate transactions take place every day in the world, and as such, there is a need for finding various types of real property for sale on the market.

Some examples of websites search mechanisms such as REALTOR.COM, TRULIA.COM, and ZILLOW.COM are commonly available in the market for property searches. The most noticeable drawback of using the existing search mechanisms on the web devices is that, prior to its use, the application software needs to be download and installed into the mobile devices as an “app”, which inevitably will require extra storage spaces in the mobile device. Secondly, the prior application also lacks the capability of showing the user whether the property is either an auction property or just a traditional sales property. And lastly, they all lack the ability to show a sale property that may span over several different addresses.

In the invention, unlike other websites purport, the implementation of an unique combination of HTML5, CSS3, and JavaScript enable offloading the search application to a server, hence allows the user the ease of directly running a browser (e.g. Chrome, Safari) on the mobile device and navigating to a URL without prior installation of the “app” software(s) as commonly required in the prior art. It is also made possible to the user, during the search, by simply entering a property geographical location (i.e., city, county, state, or zip code), an area map is prompt on the device, and one or more color coded indicator pins are simultaneously generated on the map to identify the locations and the types of properties for sale. When further clicking on a specific color coded indicators, the user is further taken to a “Property Details” page, where further detailed property information about the property is presented to the user, including address, price, land area, year built, property type, for sale or for auction, and building area etc.

### SUMMARY OF THE INVENTION

The mobile property search described here is a unique, new method for rendering property search results on a map on a mobile device. The application is powered by the following technology: HTML5, CSS3, JavaScript, a Map Background, and a web server. When a user searches for a property (e.g. by entering zip), the property locations and property types are displayed in at least one color coded indicators, When further clicking on a specific color coded indicator, the user is further taken to a “Property Details” page, where further details of property information is presented. When, the user changes the search criteria (e.g. changes zip), the JavaScript handles the event, and sends an AJAX request to the web server. The web server then responds with the new updated result set to be rendered on the screen AND the coordinates for which the map should now be centered on. When the JavaScript code gets the new results, the indicator on the map will be reset and re-rendered. All this happens without a full refresh of the page or a complete DOM reload.

### BRIEF DESCRIPTION OF THE DRAWINGS

FIG. 1: Displays the steps a user would take as they move through the app.

FIG. 2: Shows the mechanism for retrieving a fresh set of search results.

### DETAILED DESCRIPTION OF THE INVENTION

The invention intends to provide a system and methods of using an on-line worldwide web browser system to facilitate the near real-time search of real properties for sale on a web-map using mobile browser devices, such as smart phones, tablets, or any other portable web devices with web browsing capabilities.

The database used in the invention, consisting the detailed real property information,(such as property location, property type, sale price, land area, year built, for sale or for auction, building area and land use etc.), in its structure, is a relational database.

The invention detailed here provides a way for a mobile internet user to view properties on a map, whereby the user can easily determine which properties are auction properties and which properties are traditional sales by showing one or more color coded indicators on the map in different colors (e.g. auctions are red and traditional sales are blue).

The invention is unique in that the search procedure starts in a web browser running on a mobile device; the search criteria is sent to a web server via an HTTP AJAX request. MVC code on the server dispatches the request information to the database, where a set of matching results is returned. The .NET code then serializes the results into JSON (JavaScript Object Notation), making the results inherently ready to use by JavaScript. The JavaScript result handler code, executed through an asynchronous callback method, then processes the results, looping through the results to place an indicator or pin on the web map for each matching property, the pin is then color coded, and linked. Each color coded pin is further linked to provide the user with a way to see even more information (i.e. property address, price, auction/traditional sales, land area, and property type etc.). The process is repeatable, and when a user changes their search criteria, any previously rendered pins would be removed before the new results are shown. When searching for properties in a certain zip code, exact zip code matches will be highlighted, where non-matching zip codes will not. In this way, mobile web application users can see which properties are exact match for their search vs. those in its proximity.

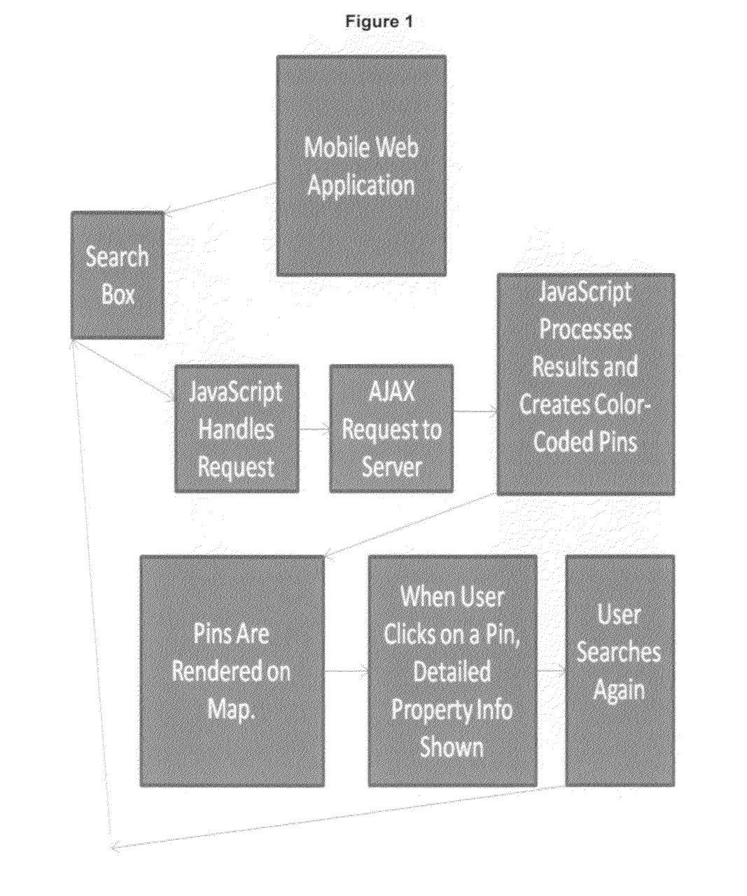

FIG. 1 illustrates the path the user would take to search for properties using this mobile application. The user starts on a mobile website, powered by HTML5, CSS3, and JavaScript. They are presented with a search form, where they can enter a zip code. When the user has indicated he is finished with the search by hitting a “Search” button, JavaScript reads the user input and serializes it into an HTTP AJAX POST Request. This AJAX POST request sends the zip code as the payload of the request. When the results are returned, JavaScript renders the pins on the map. When the user is looking at the newly rendered map, one will have the opportunity to click on one of the color coded indicator pin to see more information about that property, including: address, property type, and land area.

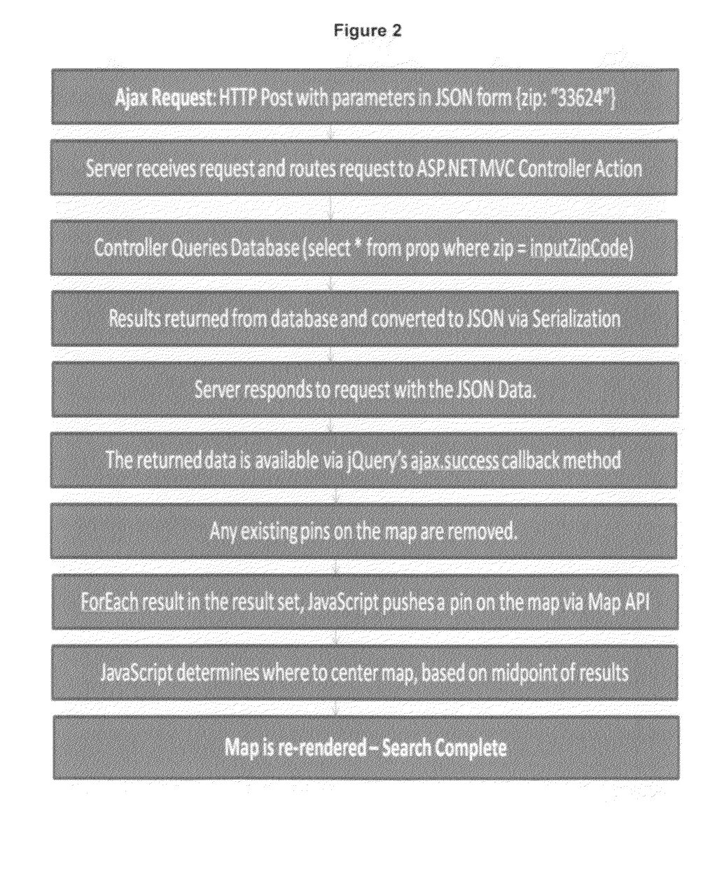

FIG. 2 illustrates the mechanism for processing the request using JavaScript, a web server, MVC controller actions, and a database. When the AJAX request is sent via HTTP to the server, the web server software routes that request to an MVC controller using the web server routing module. When a route has been determined, the controller action is invoked with the zip code as input. The controller then dispatches a request to a database, where tables are searched for properties in matching zip codes and properties in close proximity. The database returns the results to the controller action, which then serializes the results back to JSON. The web server takes the JSON data, and returns it to the mobile web user's browser in an HTTP Response. JavaScript running within the mobile web application processes the results in the asynchronous ajax.success callback method. For each result in the response data, a pin is created on the map, by utilizing the Map API. The actual map background is not part of this invention, but the map background is used to show the results. Once the pins have been placed on the map via the Map API, the map is re-rendered, making the properties visible to the user with visual indicators for sales type (i.e. auction or traditional). Additionally, the response JSON data contains geographical coordinates, making it easy to determine where to center the map. This is especially useful when a new zip code is far away from the previous zip code; the user will see the map centered on the matching results (i.e. close to the zip code just been searched).

I claim:

1. A method of using a portable mobile web browser device for locating and identifying available real property on the advertised website database including at least one of property locations, and types of sale property comprising the steps of:
(a) Sending search criteria to a web server via an HTTP AJAX request information;
(b) Processing said HTTP AJAX request information using a MVC server-side program;
(c) Dispatching said processed request information to a relational database, where a set of matching results is returned;
(d) Serializing said server-side program results into JSON code making the results inherently readable by JavaScript web application and parsing with JSON response asynchronously;
(e) Re-rendering the map by placing an coded indicator on the map utilizing the API component; and
(f) Making the properties visible to the user with color coded indicators identifying locations and types of property for sales;
(g) Displaying at least one of property details pages, when at least one of said color coded indicators being clicked.

2. The method of claim 1, wherein said search criteria comprises at least one of the search locations including: city, Zip code and state.

3. The method of claim 1, wherein said indicators comprising at least one color coded pin.

4. The method of claim 1, wherein said types of property for sale including at least one of traditional sale property and auction sale property.

5. The method of claim 1, wherein said property details pages including at least one of: property address, sale price, land area, year built, property types, and building location.

6. A mechanism for processing at least one searching request in real property search and map display system, using JavaScript, a web server, MVC actions controller, and a real property relational database, for mobile web application, comprising:
(a) Sending at least one of AJAX request in JSON form via HTTP to the server;
(b) Routing said server request to said MVC controller using web server routing module to determine a request route;
(c) Invoking at least one controller actions with said request as an input;
(d) Dispatching said input via said controller to said database for matching real property data in its proximity;
(e) Converting the returned matching data to JSON form via serialization;
(f) Receiving said JSON data via said web server and returning said data to mobile web browser in HTTP response;
(g) Processing said data in (f) via JavaScript running within the mobile web application in asynchronous callback method;
(h) Utilizing Map API to place at least one color coded indicator on the map in response to said processed data.
